(19) United States
(12) Patent Application Publication
(10) Pub. No.: US 2009/0285948 A1
(43) Pub. Date: Nov. 19, 2009

(54) BALL GAG TOY

(75) Inventor: Joel G. Tucker, Los Angeles, CA (US)

Correspondence Address: TODD S. PARKHURST;HUGHES SOCOL PIERS RESNICK & DYM LTD., THREE FIRST NATIONAL PLAZA, 70 WEST MADISON; SUITE 4000, CHICAGO, IL, 60602, US

(73) Assignee: The Stockroom, Inc., Los Angeles, CA (US)

(21) Appl. No.: 12/466,991

(22) Filed: May 15, 2009

Related U.S. Application Data
(60) Provisional application No. 61/053,919, filed on May 16, 2008.

(51) Int. Cl. A23L 1/09

(52) U.S. Cl. 426/104

(57) ABSTRACT

A novelty ball gag is disclosed and claimed. The gag includes a ball member mounted upon a rigid or flexible rod. Each end of the rod is threaded, and a strap member is secured to each rod end The straps are sized and shaped to reach around a wearer's head and can be fastened to one another by any convenient means such as a buckle so as to secure the rod in a position across a wearer's mouth. In accordance with the invention, the ball is mounted on the rod, and is formed of an edible or soluble material such as hard candy. If desired, spacer sleeves can be inserted over the rod to center the candy ball on the rod. The ball can be flavored with cinnamon, peppermint, or any other desired flavor. A mild irritant such as, black pepper may provide an unusual sensation to the gag wearer.

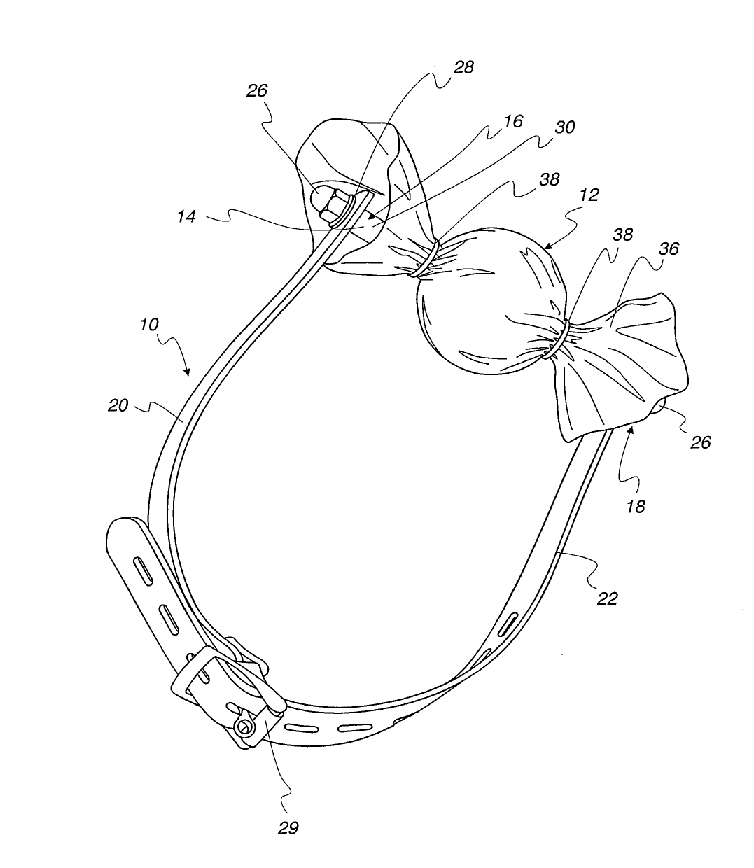

### BACKGROUND OF THE INVENTION

This invention relates generally to novelty items and more particularly concerns a ball gag toy.

The present invention is intended as a party favor for bachelor parties and other activities. The invention is intended as a humorous play on the term “gag gift” and the comical coupling of the edgy suggestiveness of Bondage Dominance Submission and Masochism (“BDSM”) and the old strategy of pacifying children with candy.

Ball gags are toys utilized in the BDSM community. Functionally, the ball portion of a ball gag is inserted into the mouth of the wearer between and behind the teeth. The straps of the gag are then extended along the side of the wearer's face, and then are joined by a buckle or other convenient means behind the wearer's head, at or above the base of the neck, thus preventing the wearer from speaking in a coherent manner.

The present invention is a variation on the traditional ball gag in which the silicone, wood, rubber or other inedible ball is replaced by an edible candy ball, such as a so-called jawbreaker. The invention permits removal and replacement of the edible gag ball. The gag device is sturdy enough to be suitable for real BDSM play, but it is less intimidating, and provides a relevant relatively lighthearted approach to those curious about BDSM, and is a novelty for regular practitioners bored with the previously marketed ball gags.

It is an object of this invention to provide a ball gag in which the ball can be at least partially dissolved by saliva or other liquids.

Another object of the invention is to provide a ball gag in which the ball provides a taste sensation in the wearer's mouth.

Other objects and advantages of the invention will become apparent upon reading the following detailed description and upon reference to the drawing.

### DESCRIPTION OF THE DRAWING

The drawing is an isometric view of a ball gag embodying the present invention.

### DETAILED DESCRIPTION

While the invention will be described in connection with a preferred embodiment, it will be understood that it is not intended to limit the invention to this embodiment. On the contrary, it is intended to cover all alternatives, modifications and equivalents as may be included within the spirit and scope of the invention as defined by the appended claims.

As illustrated in the drawing, the gag 10 includes a candy ball member 12 mounted upon a rigid or flexible rod mount 14. Each end of the rod mount 16, 18 is threaded, and a strap member 20, 22 is secured to each rod by acorn nuts (also referred to as cap nuts) 26 and washers 28. The straps 20, 22 are sized and shaped to reach around a wearer's head and can be fastened to one another by any convenient means such as a buckle 29 so as to secure the rod in a position across a wearer's mouth.

Candy balls can be obtained from the Ferrara Pan Candy Company of Forest Park Ill.; from the Sconza Candy Company of Oakdale Calif.; and from other sources.

To center the candy ball 12 on the rod 14, spacer tubes 30 can be slipped over the rod to extend from the candy ball 14 to the washers 28. The spacer tubes 30 separate and isolate the candy ball 14 from the straps 20, 22 to prevent soiling. If desired, a cellophane or other candy wrapper 36 can be fastened over the candy ball with ties 38 of any known sort.

In accordance with the invention, the ball 12 is mounted on the rod 14, and is formed of an edible or soluble material such as hard candy. The ball can be flavored with cinnamon, peppermint, or any other desired flavor. A mild irritant such as black pepper may provide an unusual sensation to the gag wearer.

When the ball has been dissolved or use of the ball and ball gag has been finished, the remnants of the ball 12 can be removed from the rod 14 by first removing a cap nut 26, and then removing the ball 12. The rod 14 and spacer tube sleeves 30 can then be cleaned and a new ball 12 installed. The strap is then re-assembled to the rod and the cap nut 26 fastened in place.

1. A ball gag toy, comprising, in combination, a rod mount, means extending around the wearer's head to secure the rod mount across a wearer's mouth, and a ball mounted upon the rod mount, wherein the ball comprises an edible or soluble material.

2. A ball gag toy according to claim 1 wherein said ball comprises an edible candy.

3 A ball gag toy according to claim 2 wherein said ball includes a peppermint flavor.

4. A ball gag toy according to claim 2wherein said ball includes a cinnamon flavoring agent.

5. A ball gag toy according to claim 2 wherein said ball includes a pepper.

6. A ball gag toy according to claim 1 further including at least one spacer tube sleeve extending over at least part of said rod mount to a position adjacent said ball.
